(19) United States
(12) Patent Application Publication
(10) Pub. No.: US 2013/0044000 A1
(43) Pub. Date: Feb. 21, 2013

(54) AWAKENED-STATE MAINTAINING APPARATUS AND AWAKENED-STATE MAINTAINING METHOD

(71) Applicants: Wataru Nakai, Hyogo (JP); Hiroyuki Kubotani, Kanagawa (JP); Yoshinobu Uno, Kanagawa (JP)

(72) Inventors: Wataru Nakai, Hyogo (JP); Hiroyuki Kubotani, Kanagawa (JP); Yoshinobu Uno, Kanagawa (JP)

(73) Assignee: PANASONIC CORPORATION, Osaka (JP)

(21) Appl. No.: 13/382,436

(22) PCT Filed: Apr. 25, 2011
(86) PCT No.: PCT/JP2011/002429

§ 371 Date: Jan. 5, 2012

(30) Foreign Application Priority Data
May 7, 2010 (JP) 2010-107419

(51) Int. Cl. G08B 23/00

(52) U.S. Cl. 340/575

(57) ABSTRACT

Provided are an awakened-state maintaining apparatus and an awakened-state maintaining method that maintain an awakened-state of a driver. In the awakened-state maintaining apparatus (100), a visual-stimulation control unit (107) calculates an initial displaying position that is in accordance with the product of initial setup time and detected vehicle speed. A displaying means displays on the initial displaying position a visual stimulation image pertaining to a visual-stimulation virtual object that will evoke an awakened-state, and also updates the visual stimulation image using a visual effect wherein the visual-stimulation virtual object is displayed so as to seemingly approach the vehicle at the detected speed, in accordance with the time elapsed since the visual stimulation image was first displayed. An audio signal control unit (105) outputs an audio signal and a vibration control unit (106) outputs a vibration, when the initial setup time has elapsed since the visual stimulation image was first displayed. Since, in such a way, a driver is able to sense that the vehicle that he/she is driving has run over the visual-stimulation virtual object, which was displayed so as to seemingly make a gradual approach to the vehicle, with his/her visual, hearing, and tactual senses, the awakened-state of the driver is able to be maintained.

### TECHNICAL FIELD

The present invention relates to an awakened-state maintaining apparatus and awakened-state maintaining method for maintaining a driver's awakened-state.

### BACKGROUND ART

When driving on a monotonous road such as a highway, drivers are likely to feel sleepy. That is, the arousal level of the drivers is likely to lower.

As a technique for preventing such a deterioration in the drivers' arousal level, an anti-dozing pavement method is known (e.g., see Patent Literature 1). According to the anti-dozing pavement method described in Patent Literature 1, projections and depressions are provided on the road surface so as to produce vibration and sound when a vehicle travels over such projections and depressions.

Furthermore, there are available vehicle-mounted audio reproducing apparatuses with an anti-dozing function (that is, awakened-state maintaining apparatuses) (e.g., see Patent Literature 2). The vehicle-mounted audio reproducing apparatus described in Patent Literature 2 generates random low-tone vibration using a speaker or vibration apparatus in a vehicle room, and thereby reproduces in a simulated manner vibration and sound produced when the vehicle travels over projections and depressions provided on the road. This allows the driver to sense projections and depressions on the road in a simulated manner without the vehicle actually traveling over projections and depressions provided on the road.

### CITATION LIST

### Patent Literature

PTL 1
Japanese Patent Application Laid-Open No. HEI 2-008401
PTL 2
Japanese Patent Application Laid-Open No. SHO 59-216393

### SUMMARY OF INVENTION

### Technical Problem

However, since the random low-tone vibration generated by the above-described conventional awakened-state maintaining apparatus is irrelevant to a traveling state and traveling environment of the vehicle, it inevitably lacks the sense of realism. For this reason, it does not produce a sufficient effect of causing the driver to have a feeling of tension either and it is difficult to extend the duration of the awakened state maintaining effect using the prior art.

It is an object of the present invention to provide an awakened-state maintaining apparatus and awakened-state maintaining method for maintaining an awakened-state of a driver by displaying an image for stimulating the driver's visual sense, a sound for stimulating the auditory sense or vibration for stimulating the tactual sense in accordance with the traveling state of the vehicle.

### Solution to Problem

An awakened-state maintaining apparatus according to an aspect of the present invention is an awakened-state maintaining apparatus mounted on a vehicle for maintaining an awakened-state of a driver of the vehicle, including a speed information acquiring section that acquires information on a speed of the vehicle, a calculation section that calculates an initial setup time based on the speed, the initial setup time being inversely proportional to the speed, a display control section that calculates an initial displaying position in accordance with the product of the initial setup time and the speed, displays at the initial displaying position a visual stimulation image pertaining to a visual stimulation virtual object that will evoke an awakened-state, and also updates the visual stimulation image using a visual effect wherein the visual stimulation virtual object is displayed so as to seemingly approach the vehicle at the speed in accordance with the time elapsed from the display timing, a sound generation control section that outputs an audio signal when the initial setup time elapses from the display timing and a vibration control section that outputs vibration when the initial setup time elapses from the display timing.

An awakened-state maintaining method according to an aspect of the present invention is an awakened-state maintaining method for maintaining an awakened-state of a driver of a vehicle, including an acquiring step of acquiring information on a speed of the vehicle, a calculating step of calculating an initial setup time based on the speed, the initial setup time being inversely proportional to the speed, a display control step of calculating an initial displaying position in accordance with the product of the initial setup time and the speed, displaying at the initial displaying position a visual stimulation image pertaining to a visual stimulation virtual object that will evoke an awakened-state and also updating the visual stimulation image using a visual effect wherein the visual stimulation virtual object is displayed so as to seemingly approach the vehicle at the speed in accordance with the time elapsed from the display timing, a sound generation controlling step of outputting an audio signal when the initial setup time elapses from the display timing and a vibration control step of outputting vibration when the initial setup time elapses from the display timing.

### Advantageous Effects of Invention

The present invention can provide an awakened-state maintaining apparatus and awakened-state maintaining method for maintaining an awakened-state of the driver by displaying an image for stimulating the driver's visual sense in accordance with the traveling state of the vehicle and generating sound for stimulating the auditory sense or vibration for stimulating the tactual sense.

### BRIEF DESCRIPTION OF DRAWINGS

FIG. 1 is a block diagram illustrating a configuration of an awakened-state maintaining apparatus according to Embodiment 1 of the present invention;

FIG. 2 is a diagram illustrating processing of a visual stimulation control section;

FIG. 3 is a diagram illustrating a display method by a visual stimulation control section;

FIG. 4 is a flowchart illustrating operation of an audio signal control section;

FIG. 5 is a flowchart illustrating operation of a vibration control section;

FIG. 6 is a flowchart illustrating operation of the visual stimulation control section;

FIG. 7 is a block diagram illustrating a configuration of an awakened-state maintaining apparatus according to Embodiment 2 of the present invention;

FIG. 8 is a flowchart illustrating operation of an audio signal control section;

FIG. 9 is a flowchart illustrating operation of a vibration control section;

FIG. 10 is a flowchart illustrating operation of a visual stimulation control section;

FIG. 11 is a block diagram illustrating a configuration of an awakened-state maintaining apparatus according to Embodiment 3 of the present invention;

FIG. 12 is a flowchart illustrating operation of a visual stimulation control section;

FIG. 13 is a diagram illustrating a positional relationship between a vehicle, camera, visual stimulation virtual object and painted line;

FIG. 14 is a block diagram illustrating a configuration of an awakened-state maintaining apparatus according to Embodiment 4 of the present invention;

FIG. 15 is a flowchart illustrating operation of a visual stimulation control section;

FIG. 16 is a diagram illustrating a positional relationship between a vehicle, camera, visual stimulation virtual object and painted line;

FIG. 17 is a diagram illustrating a positional relationship between a vehicle, camera, visual stimulation virtual object and painted line;

FIG. 18 is a diagram illustrating a positional relationship between a front window, foreground and visual stimulation image;

FIG. 19 is a block diagram illustrating a configuration of an awakened-state maintaining apparatus according to Embodiment 5 of the present invention;

FIG. 20 is a flowchart illustrating operation of a section passage deciding section;

FIG. 21 is a block diagram illustrating a configuration of an awakened-state maintaining apparatus according to Embodiment 6 of the present invention; and

FIG. 22 is a flowchart illustrating operation of a section passage deciding section.

### DESCRIPTION OF EMBODIMENTS

### Embodiment 1

[Configuration of Awakened-State Maintaining Apparatus 100]

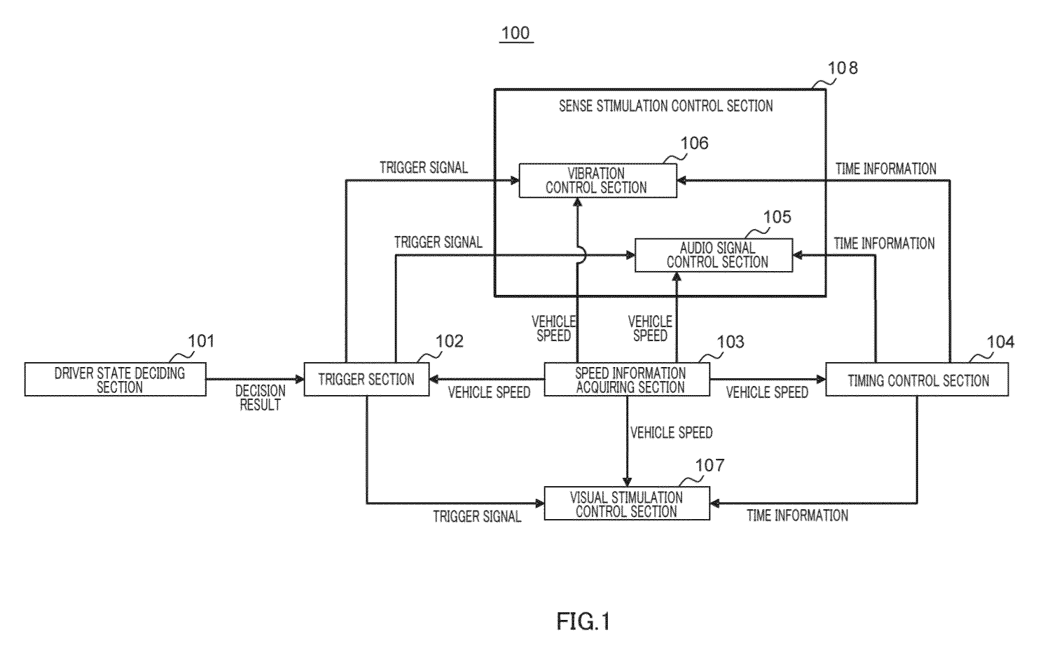

FIG. 1 is a block diagram illustrating a configuration of awakened-state maintaining apparatus 100 according to Embodiment 1 of the present invention. In FIG. 1, awakened-state maintaining apparatus 100 includes driver state deciding section 101, trigger section 102, speed information acquiring section 103, timing control section 104, sense stimulation control section 108 and visual stimulation control section 107. Sense stimulation control section 108 includes audio signal control section 105 and vibration control stimulation section 106.

A case will be described in Embodiment 1 where a speed of a vehicle is constant.

Driver state deciding section 101 decides an awakened-state of the driver of the vehicle mounted with awakened-state maintaining apparatus 100 and calculates an awakened-state level of the driver. As the decision criteria, biological information of the driver, wobbling of the vehicle, face image of the driver or the like are used. Driver state deciding section 101 repeats the processing of deciding the awakened-state of the driver at a predetermined cycle.

When the driver's biological information is used to decide an awakened-state, driver state deciding section 101 is provided with, for example, a biometric sensor and decides the driver's awakened-state based on a comparison between the measured value obtained by the biometric sensor and a predetermined threshold. Furthermore, the biometric sensor is configured with a combination of one or a plurality of a brain wave sensor, pulse wave sensor, heart beat sensor, respiratory sensor and blood pressure sensor.

Furthermore, when wobbling of the vehicle is used to decide the awakened-state, driver state deciding section 101 calculates a movement amount of the vehicle in the lateral direction based on information acquired from the vehicle and decides the driver's awakened-state based on a comparison between a variance of the movement amount and a predetermined threshold. Examples of the information acquired from the vehicle include a steering angle and acceleration in the lateral direction of the vehicle.

On the other hand, when the driver's face image is used to decide the awakened-state, driver state deciding section 101 decides the driver's awakened-state based on the driver's face image picked up by a camera set up, for example, in the vehicle room.

Trigger section 102 outputs a trigger signal based on the decision result of driver state deciding section 101 to audio signal control section 105, vibration control section 106 and visual stimulation control section 107. To be more specific, when the decision result of driver state deciding section 101 shows that the driver's awakened-state level has lowered to a predetermined level or below, trigger section 102 outputs a trigger signal. Furthermore, trigger section 102 outputs a trigger signal at a time interval corresponding to a vehicle speed acquired from speed information acquiring section 103. In the following descriptions, the present Description assumes that a lower awakened-state level is an indicative of stronger drowsiness.

To be more specific, trigger section 102 checks the driver's awakened-state level at a predetermined cycle based on the decision result of driver state deciding section 101 and outputs, upon confirming that the driver's awakened-state level has lowered to the predetermined level or below, a first trigger signal to audio signal control section 105, vibration control section 106 and visual stimulation control section 107. Trigger section 102 then calculates timing at which the next trigger signal (that is, a second trigger signal) is outputted (that is, time interval t between output timings at which two consecutive trigger signals are outputted) based on speed information V received from speed information acquiring section 103. When time interval t elapses from the output timing of the first trigger signal, trigger section 102 checks the driver's awakened-state level calculated by driver state deciding section 101.

When the checked driver's awakened-state level remains at the predetermined level or below, trigger section 102 outputs a second trigger signal. On the other hand, when the driver's awakened-state level calculated by driver state deciding section 101 has increased to a predetermined level or above, trigger section 102 stops outputting the second trigger signal. When outputting the second trigger signal, trigger section 102 calculates timing at which the next trigger signal (that is, a third trigger signal) is outputted (that is, time interval t between output timings at which two consecutive trigger signals are outputted) based on speed information V received from speed information acquiring section 103 again.

In the present embodiment, since the speed of the vehicle does not change, speed information V is always the same. When time interval t elapses from the output timing of the second trigger signal, trigger section 102 checks the driver's awakened-state level based on the decision result of driver state deciding section 101. When the checked driver's awakened-state level has lowered to a predetermined level or below, trigger section 102 outputs a third trigger signal. On the other hand, when the driver's awakened-state level has increased to the predetermined level or above, trigger section 102 stops outputting the third trigger signal. Trigger section 102 continues to repeatedly output a trigger signal at time interval t until the driver's awakened-state level based on the decision result of driver state deciding section 101 increases to the predetermined level or above. When the driver's awakened-state level calculated by driver state deciding section 101 has increased to the predetermined level or above and no trigger signal is outputted, trigger section 102 checks the driver's awakened-state level calculated by driver state deciding section 101 at a predetermined cycle again.

When trigger section 102 performs the above-described processing, a trigger signal is repeatedly outputted to audio signal control section 105, vibration control section 106 and visual stimulation control section 107 only for a period during which the driver's awakened-state level based on the decision result of driver state deciding section 101 is low.

Here, above-described time interval t is equivalent to a time interval at which the vehicle passes over projections and depressions provided on the actual road surface and may be set to a certain value corresponding to speed information V or a random value. When time interval t is set to a certain value corresponding to speed information V, trigger section 102 assumes that speed information V received from speed information acquiring section 103 is inversely proportional to time interval t.

In the present embodiment, since speed information V of the vehicle is constant, time interval t is always constant for the same vehicle. Furthermore, when time interval t is set to a certain value corresponding to speed information V, since speed information V is assumed to be inversely proportional to time interval t, a vehicle having a greater speed information V value (vehicle speed is faster) has a higher frequency with which trigger information is outputted.

On the other hand, when time interval t is assumed to be a random value, trigger section 102 uses a value determined according to speed information V and a probability distribution received from speed information acquiring section 103. This probability distribution may be a uniform distribution between two values assuming a value inversely proportional to speed information V received from speed information acquiring section 103 as the central axis or may be a distribution between two values of a normal distribution assuming a value inversely proportional to speed information V received from speed information acquiring section 103 as the central axis.

Here, time interval t is assumed to be equivalent to the time interval at which the vehicle passes over projections and depressions provided on the actual road surface, but time interval t may be longer or shorter than a general time interval at which the vehicle passes over projections and depressions provided on the actual road surface.

Speed information acquiring section 103 acquires information on the speed of the vehicle. The following method is available as the method of acquiring information on the speed of the vehicle. To be more specific, for example, speed information acquiring section 103 acquires the number of revolutions of a turbine of a torque converter provided for a change gear of the vehicle and the number of revolutions of a vehicle axle of the change gear or the like as speed information from the change gear. Furthermore, speed information acquiring section 103 may also acquire speed information based on a vehicle speed pulse signal obtained from the vehicle. Speed information acquiring section 103 may also acquire speed information via a vehicle-mounted network such as a CAN interface. CAN is an abbreviation of Controller Area Network, which is one of networks used for data transfer between vehicle-mounted devices.

The speed information acquired in this way is outputted to trigger section 102, timing control section 104, audio signal control section 105, vibration control section 106 and visual stimulation control section 107.

Timing control section 104 receives the speed information from speed information acquiring section 103 and controls timing of displaying on a display apparatus an image for stimulating the driver's visual sense (hereinafter referred to as “visual stimulation image”) and the displaying position, timing of generating a sound for stimulating the driver's auditory sense (hereinafter referred to as “auditory sense stimulation sound”) and timing of generating vibration for stimulating the driver's tactual sense (hereinafter referred to as “tactual sense stimulation vibration”) based on the speed information. The above-described control is performed by time information T generated by timing control section 104 being outputted to audio signal control section 105, vibration control section 106 and visual stimulation control section 107.

To be more specific, timing control section 104 determines a value inversely proportional to speed information V received from speed information acquiring section 103 as time information T. Although, details will be described later, a visual stimulation image is displayed on the display apparatus substantially simultaneously with the trigger signal output, and after a lapse of time information T, a visual sense stimulation sound and tactual sense stimulation vibration are outputted which cause the driver to feel as if the vehicle had passed over a virtual object (hereinafter referred to as “visual stimulation virtual object”) expressed by a visual stimulation image for stimulating the visual sense.

Time information T determines the position at which the visual stimulation image generated by visual stimulation control section 107 is displayed. Furthermore, time information T determines output timing of the auditory sense stimulation sound by audio signal control section 105 and output timing of the tactual sense stimulation vibration by vibration control section 106.

After acquiring the trigger signal from trigger section 102, audio signal control section 105 acquires speed information V from speed information acquiring section 103 and acquires time information T from timing control section 104. Audio signal control section 105 then generates an auditory sense stimulation sound and outputs, when time information T elapses from the timing of acquiring the trigger signal from trigger section 102, the auditory sense stimulation sound to a speaker.

The auditory sense stimulation sound generated by audio signal control section 105 is recognized by the driver of the vehicle as a sound when the vehicle passes over the visual stimulation virtual object. Therefore, a predetermined sound corresponding to speed information V may be used as the auditory sense stimulation sound.

As the auditory sense stimulation sound generated by audio signal control section 105, an arbitrary sound may be selected from a sound database, or a sound may be selected from a sound database corresponding to speed information V or a sound may be generated by processing a basic sound according to speed information V. Here, the “basic sound” refers to an auditory sense stimulation sound at a specific speed processed according to speed information V.

Here, the above-described sound database stores sound data of various heights and lengths. The sound database is stored in a storage medium (e.g., DVD, hard disk) set up in the vehicle room.

Furthermore, as an example of the method of processing the basic sound, a sound presenting time (that is, a sound generation time) is made to be inversely proportional to speed information V acquired from speed information acquiring section 103 and the sound height is made to be proportional to speed information V acquired from speed information acquiring section 103. As the basic sound, a sound is used which is actually generated and recorded when the vehicle passes over projections and depressions provided on the actual road surface. The basic sound may be a sound acquired from a sound database or a sound directly acquired from outside the vehicle such as a traveling sound.

Here, it is presupposed that audio signal control section 105 outputs one auditory sense stimulation sound every time it acquires one trigger signal outputted from trigger section 102, but the present invention is not limited to this. For example, an auditory sense stimulation sound may be outputted again a certain time after the first auditory sense stimulation sound is outputted. This makes it possible to reproduce a sound produced more realistically when the vehicle travels over projections and depressions provided on the actual road surface.

As the certain time after the first auditory sense stimulation sound is outputted until another auditory sense stimulation sound is outputted again, a value obtained by dividing the wheel base of the vehicle by speed information V may be used. This allows the driver of the vehicle to feel as if the front tires and back tires had passed over the visual stimulation virtual object.

Upon acquiring a trigger signal from trigger section 102, vibration control section 106 acquires speed information V from speed information acquiring section 103 and acquires time information T from timing control section 104. Vibration control section 106 then generates tactual sense stimulation vibration corresponding to speed information V and controls a vibration generation apparatus so as to output tactual sense stimulation vibration when time information T elapses from the timing of acquiring the trigger signal. Here, the “vibration generation apparatus” refers to an apparatus that vibrates a target.

As the tactual sense stimulation vibration generated by vibration control section 106, predetermined vibration corresponding to speed information V is used. As the tactual sense stimulation vibration generated by vibration control section 106, arbitrary vibration may be selected from a vibration database or vibration may be selected from a vibration database corresponding to speed information V or vibration may be generated by processing the basic vibration according to speed information V. Here, the “basic vibration” refers to tactual sense stimulation vibration at a certain specific speed processed according to speed information V.

Here, the above-described vibration database stores vibration data having various intensities and lengths. The vibration database is stored in a storage medium (e.g., DVD, hard disk) set up in the vehicle room.

Furthermore, as the method of processing basic vibration, a vibration presentation time (that is, a vibration time) may be made to be inversely proportional to speed information V acquired from speed information acquiring section 103 or the intensity of vibration may be made to be proportional to speed information V acquired from speed information acquiring section 103 or these different methods may be combined.

It is presupposed here that vibration control section 106 outputs one tactual sense stimulation vibration every time it acquires one trigger signal outputted from trigger section 102, but the present invention is not limited to this. For example, vibration may be outputted again a certain time after the first vibration output. This makes it possible to reproduce vibration produced more realistically when the vehicle travels over projections and depressions provided on the actual road surface. Furthermore, as the certain time after the first vibration is outputted until vibration is outputted again, a value obtained by dividing the wheel base of the vehicle by speed information V may be used. This allows the driver of the vehicle to feel as if the front tires and back tires had passed over the visual stimulation virtual object.

Here, the vibration generation apparatus that outputs tactual sense stimulation vibration may be set up in the following locations. The vibration generation apparatus may be set up on a steering wheel, driver seat, acceleration pedal, brake pedal, clutch pedal or a combination thereof.

Upon acquiring a trigger signal from trigger section 102, visual stimulation control section 107 acquires speed information V from speed information acquiring section 103 and time information T from timing control section 104. Visual stimulation control section 107 then displays a visual stimulation image on the display apparatus and updates the visual stimulation image based on speed information V and time information T.

To be more specific, visual stimulation control section 107 determines characteristics such as the shape, size and color of the visual stimulation virtual object first. The visual stimulation virtual object preferably has characteristics such as the shape, size and color close to those of projections and depressions provided on the actual road surface. That is, the shape of the visual stimulation virtual object is preferably slightly convex-shaped rectangular parallelepiped but may also be largely convex-shaped. Furthermore, the cross section of the visual stimulation virtual object may be triangular or semi-circular.

Furthermore, the length of the visual stimulation virtual object is preferably equal to the width of the lane, but the visual stimulation virtual object may be divided into right and left. Furthermore, the color of the visual stimulation virtual object is preferably a color having large contrast with respect to the road surface, but may be any color as long as it is a color that would not be confused with other display colors. Visual stimulation control section 107 generates a visual stimulation image based on visual stimulation virtual object information illustrating characteristics such as the shape, size and color determined in this way. The characteristics such as the shape, size and color of the visual stimulation virtual object may be set beforehand.

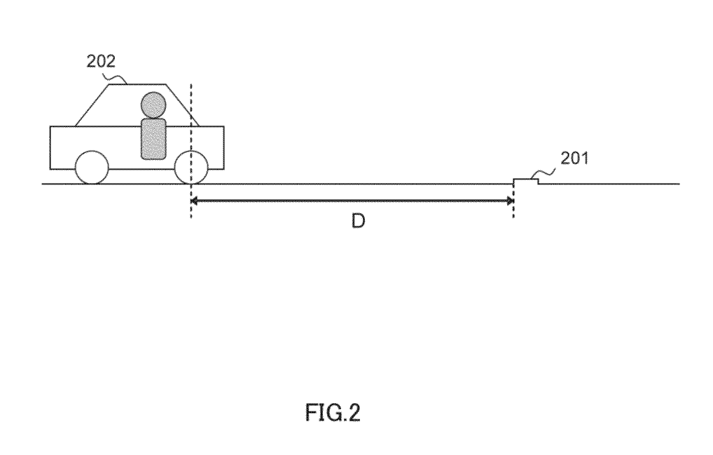

Furthermore, visual stimulation control section 107 calculates virtual distance D between the vehicle and the visual stimulation virtual object in a real space based on speed information V and time information T as displaying position information. Virtual distance D is a distance between vehicle 202 and visual stimulation virtual object 201 when visual stimulation virtual object 201 is assumed to be placed in the real space as illustrated in FIG. 2. As described above, time information T is a value inversely proportional to speed information V. This causes the visual stimulation image to always start to be displayed to the driver from a position at a certain distance regardless of the vehicle speed.

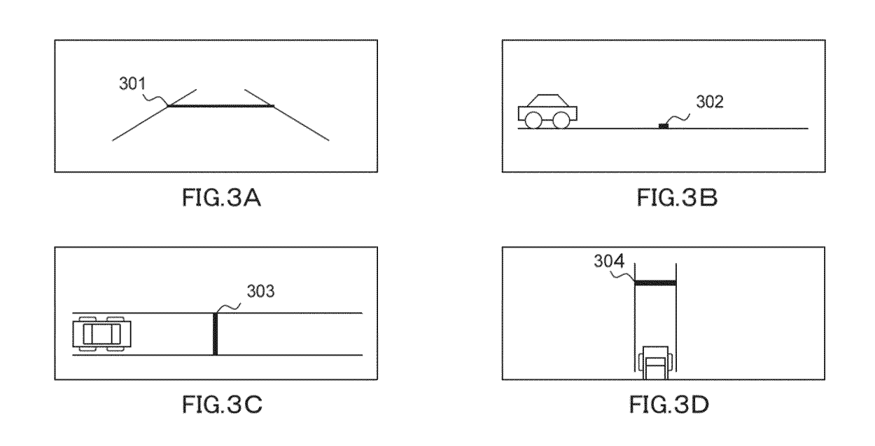

Furthermore, visual stimulation control section 107 determines a display method when displaying the visual stimulation virtual object. Examples of the display method include a method of displaying on a display apparatus such as a display of a car navigation system, visual stimulation image 301 of visual stimulation virtual object 201 on the road surface from the driver's perspective in a real space as illustrated in FIG. 3A, a method of displaying visual stimulation image 302 when the vehicle and visual stimulation virtual object 201 are viewed from one side as illustrated in FIG. 3B and methods of displaying visual stimulation images 303 and 304 when the vehicle and visual stimulation virtual object 201 are viewed from right above as illustrated in FIG. 3C and FIG. 3D. Visual stimulation control section 107 generates a visual stimulation image based on the display method information describing the display methods determined in this way. The display method may be set beforehand.

Next, visual stimulation control section 107 updates virtual distance D at a predetermined time as time advances. Since the vehicle approaches the visual stimulation virtual object as time advances (as the vehicle advances), virtual distance D becomes shorter.

Thus, visual stimulation control section 107 arranges a visual stimulation virtual object expressed by visual stimulation virtual object information at a position in a virtual space corresponding to the displaying position information, generates a visual stimulation image for displaying the visual stimulation virtual object according to the display method information and displays the generated visual stimulation image on the display apparatus.

[Operation of Awakened-State Maintaining Apparatus 100]

Operation of awakened-state maintaining apparatus 100 having the above-described configuration will be described. Here, the explanation will be focused on processing of audio signal control section 105, vibration control section 106 and visual stimulation control section 107.

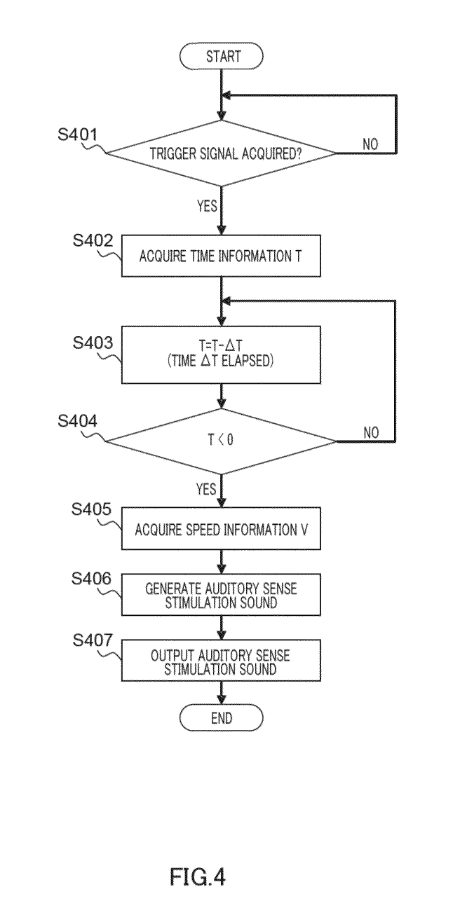

FIG. 4 is a flowchart illustrating operation of audio signal control section 105.

In step S401, audio signal control section 105 decides whether or not a trigger signal has been acquired from trigger section 102 and when a trigger signal is received, audio signal control section 105 acquires time information T from timing control section 104 in step S402. Timing at which time information T elapses after audio signal control section 105 received a trigger signal is timing at which auditory sense stimulation sound data is outputted from audio signal control section 105 to a speaker and a sound is produced.

In step S403, audio signal control section 105 subtracts predetermined time ΔT (that is, elapsed time) from time information T stored at the current point in time and thereby calculates updated time information T. That is, audio signal control section 105 counts down the initial setup time.

In step S404, audio signal control section 105 decides whether or not updated time information T is less than zero and if not less than zero (NO), audio signal control section 105 performs the processing in step S403 again. The processing in step S403 and step S404 is repeated until updated time information T is decided to be less than zero (that is, until sound generation timing is reached).

When updated time information T is decided to be less than zero (step S404: YES), audio signal control section 105 acquires speed information V from speed information acquiring section 103 in step S405, generates an auditory sense stimulation sound in step S406 and outputs the auditory sense stimulation sound in step S407.

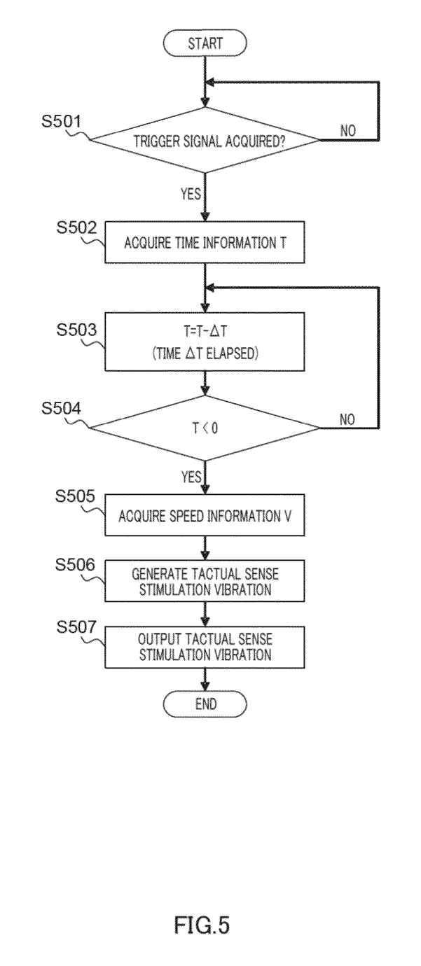

FIG. 5 is a flowchart illustrating operation of vibration control section 106.

In step S501, vibration control section 106 decides whether or not a trigger signal has been acquired from trigger section 102 and when it receives the trigger signal, vibration control section 106 acquires time information T from timing control section 104 in step S502. Timing at which time information T elapses after vibration control section 106 receives the trigger signal is timing at which tactual sense stimulation vibration data is outputted from vibration control section 106 to the vibration generation apparatus and vibration is generated.

In step S503, vibration control section 106 subtracts predetermined time ΔT (that is, elapsed time) from time information T stored at the current point in time and thereby calculates updated time information T. That is, vibration control section 106 counts down the initial setup time.

In step S504, vibration control section 106 decides whether or not updated time information T is less than zero and if not less than zero (NO), vibration control section 106 performs the processing in step S503 again. The processing in step S503 and step S504 is repeated until updated time information T is decided to be less than zero (that is, until vibration generation timing is reached).

When updated time information T is decided to be less than zero (step S504: YES), vibration control section 106 acquires speed information V from speed information acquiring section 103 in step S505, generates tactual sense stimulation vibration in step S506 and outputs tactual sense stimulation vibration in step S507.

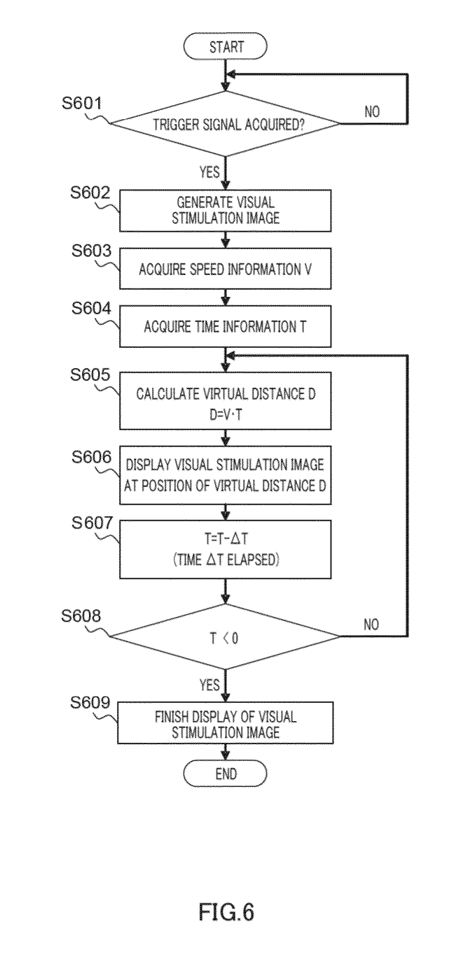

FIG. 6 is a flowchart illustrating operation of visual stimulation control section 107.

In step S601, visual stimulation control section 107 decides whether or not a trigger signal has been acquired from trigger section 102 and when receiving the trigger signal, visual stimulation control section 107 generates a visual stimulation image in step S602.

In step S603 and step S604, visual stimulation control section 107 acquires speed information V from speed information acquiring section 103 and time information T from timing control section 104.

In step S605, visual stimulation control section 107 calculates virtual distance D based on speed information V and time information T.

In step S606, visual stimulation control section 107 performs control of displaying a visual stimulation image at a displaying position corresponding to virtual distance D.

The processing in step S601 to step S606 described above is performed as a series of processing in a short time. Therefore, the visual stimulation image starts to be displayed substantially simultaneously with timing at which the trigger signal is received. On the other hand, as described above, the auditory sense stimulation sound generation timing and the tactual sense stimulation vibration generation timing are a point in time at which time information T elapses after receiving the trigger signal.

In step S607, visual stimulation control section 107 subtracts predetermined time ΔT (that is, elapsed time) from time information T stored at the current point in time and thereby calculates updated time information T. That is, visual stimulation control section 107 counts down the initial setup time.

In step S608, visual stimulation control section 107 decides whether or not updated time information T is less than zero and if not less than zero (NO), visual stimulation control section 107 performs the processing in steps S605 to S608 again. The processing in steps S605 to S608 is repeated until updated time information T is decided to be less than zero. Since virtual distance D is a value proportional to time information T, when this loop is repeated, the value of time information T is decremented by ΔT, and therefore the value of virtual distance D also gradually decreases. Thus, the visual stimulation image is displayed on the display apparatus such that the driver feels as if the visual stimulation image were approaching the vehicle.

When updated time information T is decided to be less than zero (step S608: YES), visual stimulation control section 107 performs control to finish displaying the visual stimulation image (step S609). Here, when updated time information T is decided to be less than zero, an auditory sense stimulation sound is generated simultaneously and tactual sense stimulation vibration is generated, and therefore the driver can feel with his/her visual, auditory and tactual senses that the vehicle has passed over the visual stimulation virtual object displayed so as to seemingly approach the vehicle gradually. Thus, it is possible to maintain the driver's awakened-state by generating an image for stimulating the driver's visual sense, sound for stimulating the auditory sense and vibration for stimulating the tactual sense according to the traveling state of the vehicle.

As described above, according to the present embodiment, visual stimulation control section 107 in awakened-state maintaining apparatus 100 displays a visual stimulation image pertaining to a visual stimulation virtual object that will evoke an awakened-state. In accordance with the time elapsed from the first display timing of the visual stimulation image, visual stimulation control section 107 updates the visual stimulation image using a visual effect wherein the visual stimulation virtual object is displayed so as to seemingly approach the vehicle as the vehicle advances. When time information T elapses from the first display timing of the visual stimulation image, audio signal control section 105 generates an auditory sense stimulation sound and vibration control section 106 outputs tactual sense stimulation vibration.

By this means, the driver can feel with his/her visual, auditory and tactual senses as if the vehicle had passed over the visual stimulation virtual object displayed so as to seemingly approach gradually. This makes it possible to maintain the driver's awakened-state.

It has been assumed in the above description that sense stimulation control section 108 includes audio signal control section 105 and vibration control stimulation section 106, but sense stimulation control section 108 may include one of the two. In such a case, the trigger signal outputted from trigger section 102, vehicle speed outputted from speed information acquiring section 103 and time information outputted from timing control section 104 are outputted to sense stimulation control section 108 one by one. When sense stimulation control section 108 includes only audio signal control section 105, the trigger signal, vehicle speed and tune information are outputted to audio signal control section 105. When sense stimulation control section 108 includes only vibration control stimulation section 106, the trigger signal, vehicle speed and time information are outputted to vibration control stimulation section 106. This makes it possible to obtain effects enough to maintain the driver's awakened-state even with a small number of parts.

### Embodiment 2

Embodiment 2 will describe a case where the speed of the vehicle changes.

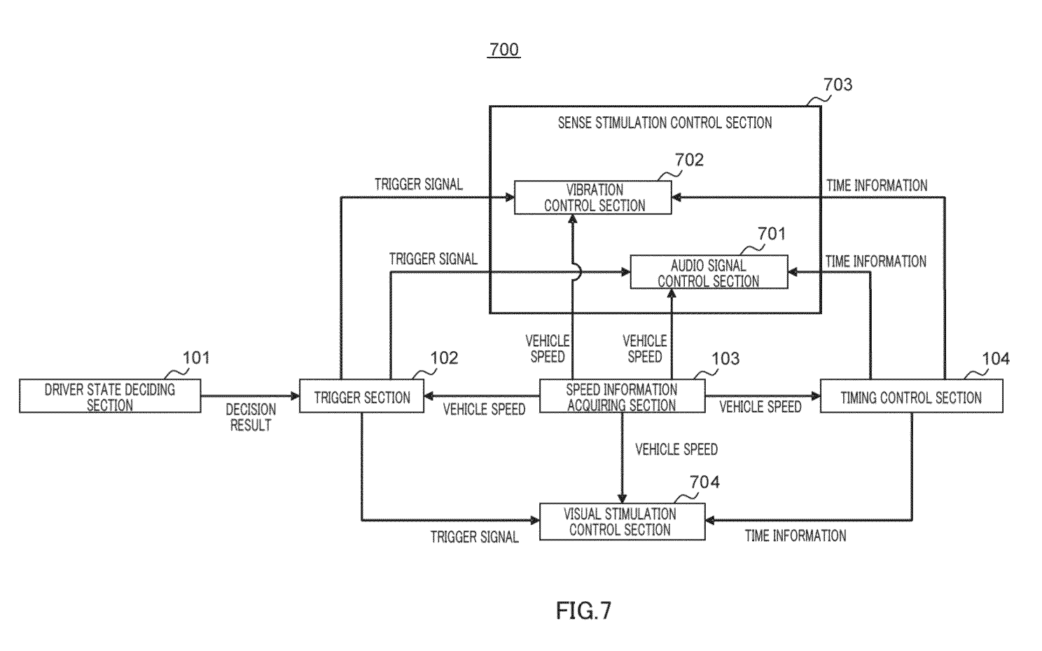

FIG. 7 is a block diagram illustrating a configuration of awakened-state maintaining apparatus 700 according to Embodiment 2 of the present invention. In FIG. 7, awakened-state maintaining apparatus 700 includes driver state deciding section 101, trigger section 102, speed information acquiring section 103, timing control section 104, sense stimulation control section 703 and visual stimulation control section 704. Sense stimulation control section 703 includes audio signal control section 701 and vibration control section 702. In the present embodiment, the same components as those in Embodiment 1 will be assigned the same reference numerals and descriptions thereof will be omitted.

Audio signal control section 701 basically includes the same function as that of audio signal control section 105. When the value (V0) of speed information V acquired last time is different from the value of speed information V acquired this time (that is, the speed of the vehicle has changed), audio signal control section 701 updates current time information T based on a ratio of the value of speed information V acquired last time to the value of speed information V acquired this time. That is, the time until an auditory sense stimulation sound is generated is updated every time speed information of the vehicle changes.

Vibration control section 702 basically has the same function as that of vibration control section 106. When the value (V0) of speed information V acquired last time is different from the value of speed information V acquired this time (that is, the speed of the vehicle has changed), vibration control section 702 updates current time information T based on the ratio of the value of speed information V acquired last time to the value of speed information V acquired this time. That is, the time until tactual sense stimulation vibration is generated is updated every time the speed information of the vehicle is changed.

Visual stimulation control section 704 basically has the same function as that of visual stimulation control section 107. When the value (V0) of speed information V acquired last time is different from the value of speed information V acquired this time (that is, the speed of the vehicle has changed), visual stimulation control section 704 updates current time information T based on the ratio of the value of speed information V acquired last time to the value of speed information V acquired this time.

Operation of awakened-state maintaining apparatus 700 having the above-described configuration will be described. Here, the explanation will be focused on processing of audio signal control section 701, vibration control section 702 and visual stimulation control section 704.

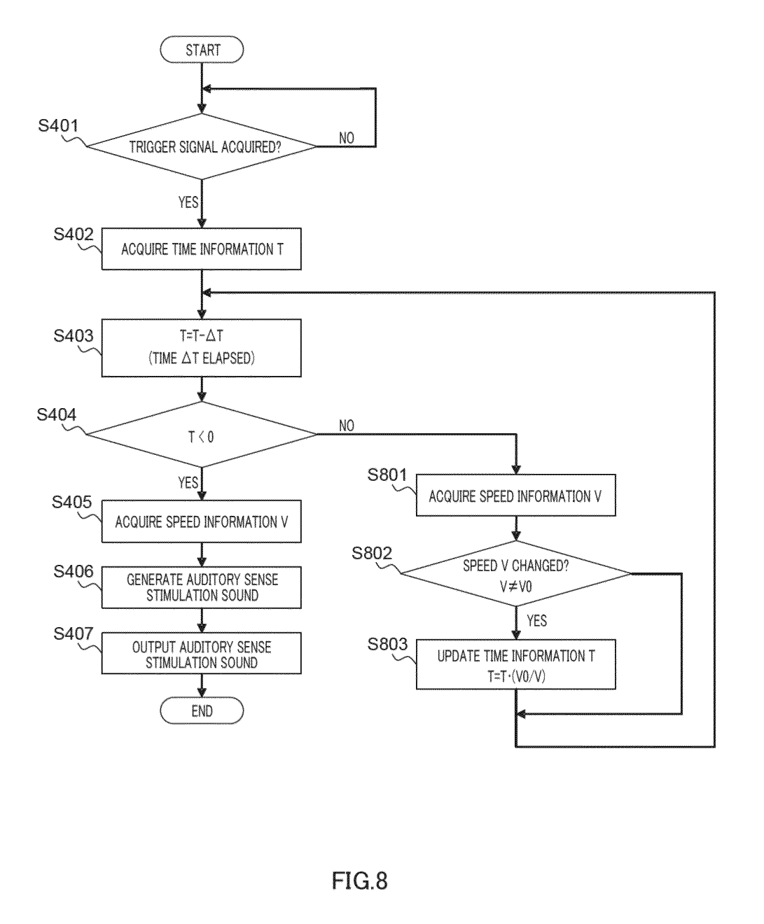

FIG. 8 is a flowchart illustrating operation of audio signal control section 701. Operation in step S401 to step S407 is the same as the operation of audio signal control section 105 illustrated in FIG. 4, and therefore descriptions thereof will be omitted.

When it is decided in step S404 that updated time information T is not less than zero, audio signal control section 701 acquires speed information V from speed information acquiring section 103 in step S801 and decides in step S802 whether or not the value of speed information V acquired this time is different from the value (V0) of speed information V acquired last time.

When the value of speed information V acquired this time is different from the value (V0) of speed information V acquired last time, audio signal control section 701 multiplies time information T stored at the current point in time by a ratio of the value (V0) of speed information V acquired last time to the value of speed information V acquired this time and thereby performs processing of updating time information T in step S803. That is, the time until an auditory sense stimulation sound is generated is updated according to the ratio before and after the change of the speed information of the vehicle.

On the other hand, when the value of speed information V acquired this time is equal to the value (V0) of speed information V acquired last time, audio signal control section 701 does not perform processing of updating time information T.

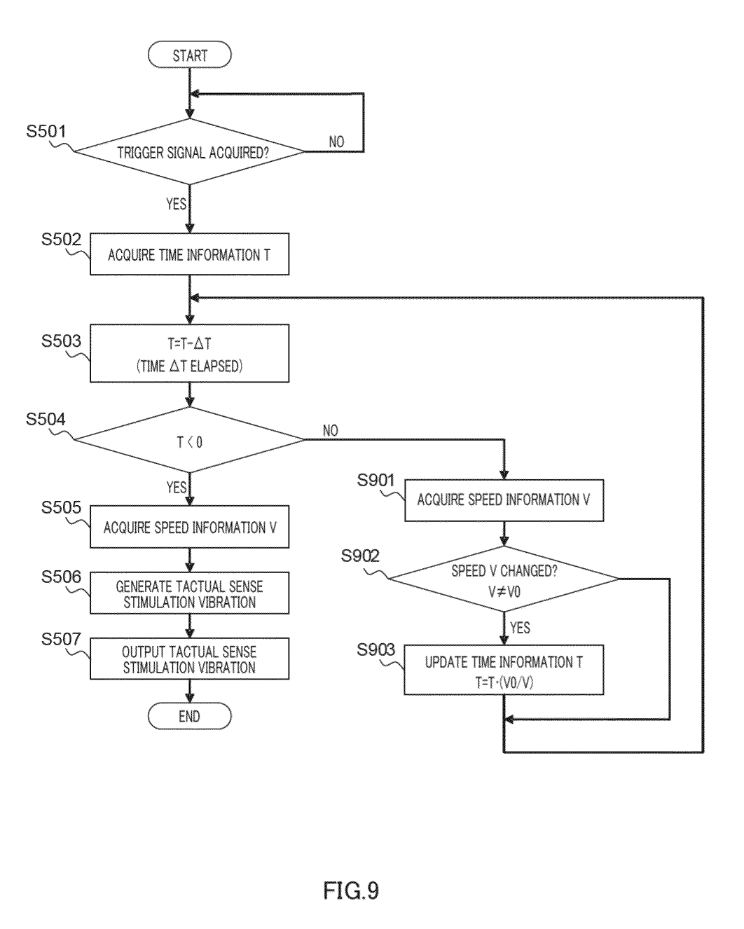

FIG. 9 is a flowchart illustrating operation of vibration control section 702. Operation in step S501 to step S507 is the same as the operation of vibration signal control section 106 illustrated in FIG. 5, and therefore descriptions thereof will be omitted.

When it is decided in step S504 that updated time information T is not less than zero, vibration control section 702 acquires speed information V from speed information acquiring section 103 in step S901 and decides in step S902 whether or not the value of speed information V acquired this time is different from the value (V0) of speed information V acquired last time.

When the value of speed information V acquired this time is different from the value (V0) of speed information V acquired last time, vibration control section 702 multiplies time information T stored at the current point in time by a ratio of the value (V0) of speed information V acquired last time to the value of speed information V acquired this time and thereby performs processing of updating time information T in step S903. That is, the time until tactual sense stimulation vibration is generated is updated according to the ratio before and after the change of the speed information of the vehicle.

On the other hand, when the value of speed information V acquired this time is equal to the value (V0) of speed information V acquired last time, vibration control section 702 does not perform processing of updating time information T.

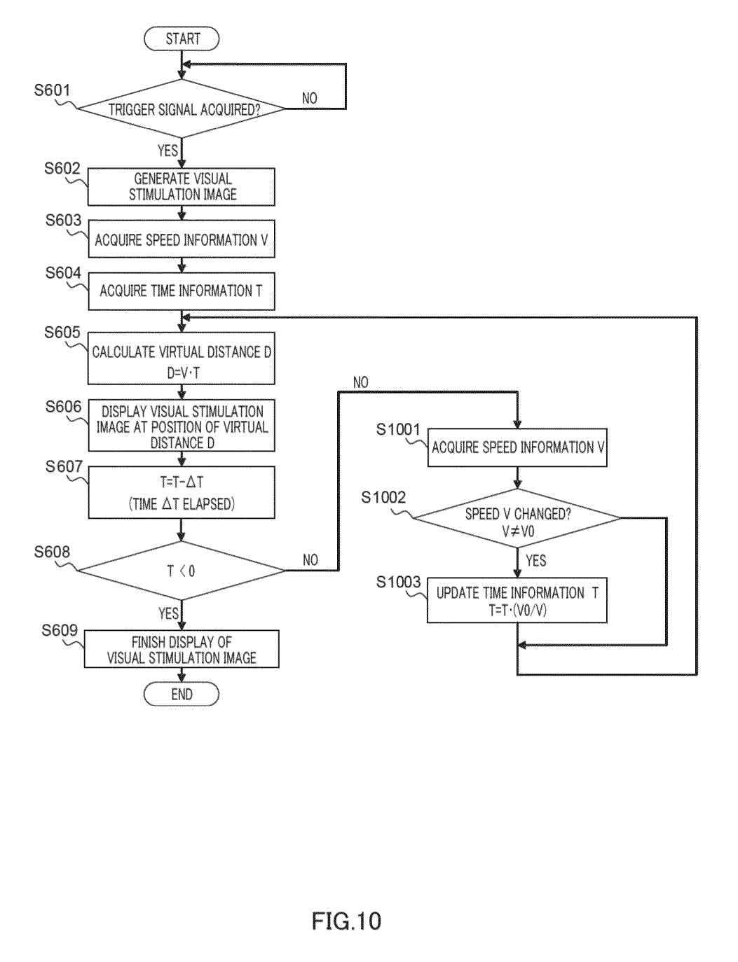

FIG. 10 is a flowchart illustrating operation of visual stimulation control section 704. Operation in step S601 to step S609 is the same as the operation of visual stimulation control section 107 illustrated in FIG. 6, and therefore descriptions thereof will be omitted.

When it is decided in step S608 that updated time information T is not less than zero, visual stimulation control section 704 acquires speed information V in step S1001 and decides in step S1002 whether or not the value of speed information V acquired this time is different from the value (V0) of speed information V acquired last time.

When the value of speed information V acquired this time is different from the value (V0) of speed information V acquired last time, visual stimulation control section 704 multiplies time information T stored at the current point in time by a ratio of the value (V0) of speed information V acquired last time to the value of speed information V acquired this time, and thereby performs processing of updating time information T in step S1003.

Thus, according to the present embodiment, when the vehicle speed changes, audio signal control section 701, vibration control section 702 and visual stimulation control section 704 of awakened-state maintaining apparatus 700 update the remaining time based on the speeds before and after the change.

By so doing, it is possible to improve the accuracy of the displaying position of a visual stimulation image and audio signal, vibration output timing in response to acceleration/deceleration of the vehicle when a trigger signal is outputted and thereafter and increase the awakened-state maintaining effect.

Although it has been assumed in the above description that sense stimulation control section 703 includes audio signal control section 701 and vibration control stimulation section 702, sense stimulation control section 703 may include one of the two. In such a case, the trigger signal outputted from trigger section 102, vehicle speed outputted from speed information acquiring section 103 and time information outputted from timing control section 104 are outputted to sense stimulation control section 703 one by one. When sense stimulation control section 703 includes only audio signal control section 701, the trigger signal, vehicle speed and time information are outputted to audio signal control section 701. When sense stimulation control section 703 includes only vibration control stimulation section 702, the trigger signal, vehicle speed and time information are outputted to audio signal control section 702. This makes it possible to obtain effects enough to maintain the driver's awakened-state even with a small number of parts.

### Embodiment 3

In Embodiment 3, a visual stimulation image is displayed superimposed on an image actually captured by an image pickup section.

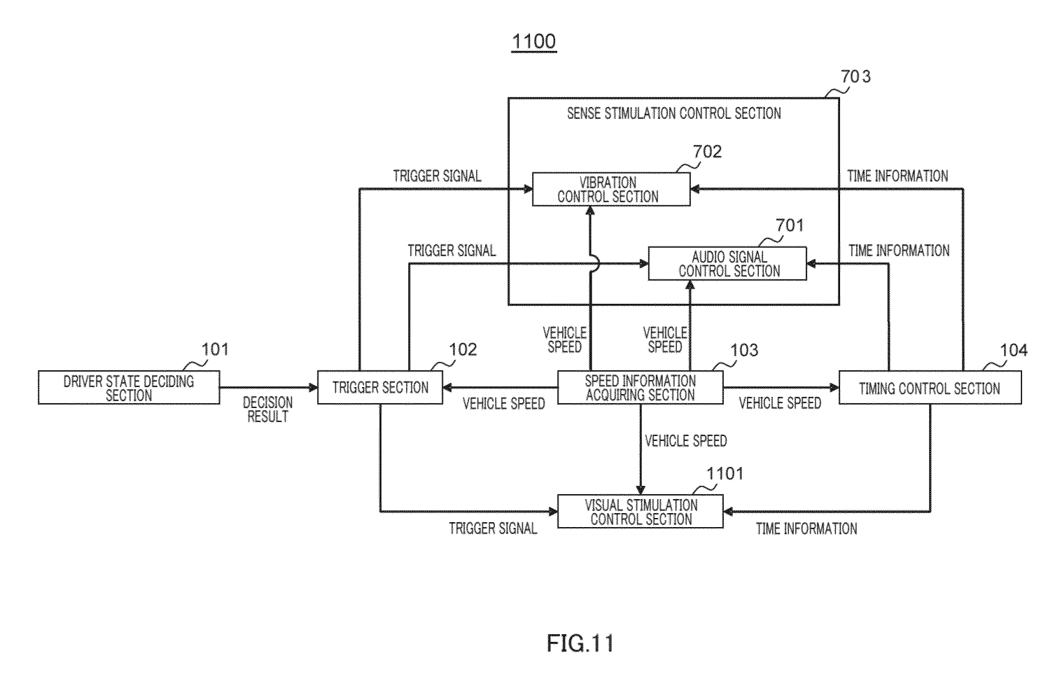

FIG. 11 is a block diagram illustrating a configuration of awakened-state maintaining apparatus 1100 according to Embodiment 3 of the present invention. In FIG. 11, awakened-state maintaining apparatus 1100 includes driver state deciding section 101, trigger section 102, speed information acquiring section 103, timing control section 104, sense stimulation control section 703 and visual stimulation control section 1101. In the present embodiment, the same components as those in Embodiment 1 or Embodiment 2 will be assigned the same reference numerals and descriptions thereof will be omitted.

Visual stimulation control section 1101 basically includes the same function as that of visual stimulation control section 704. Visual stimulation control section 1101 detects a road shape from an image in front of the vehicle photographed by a camera mounted on the vehicle (hereinafter referred to as “forward image”) and generates a visual stimulation image based on the detected road shape. Visual stimulation control section 1101 then generates a superimposed image obtained by superimposing the forward image and the visual stimulation image. This superimposed image is outputted to and displayed on a display section.

Operation of awakened-state maintaining apparatus 1100 having the above-described configuration will be described.

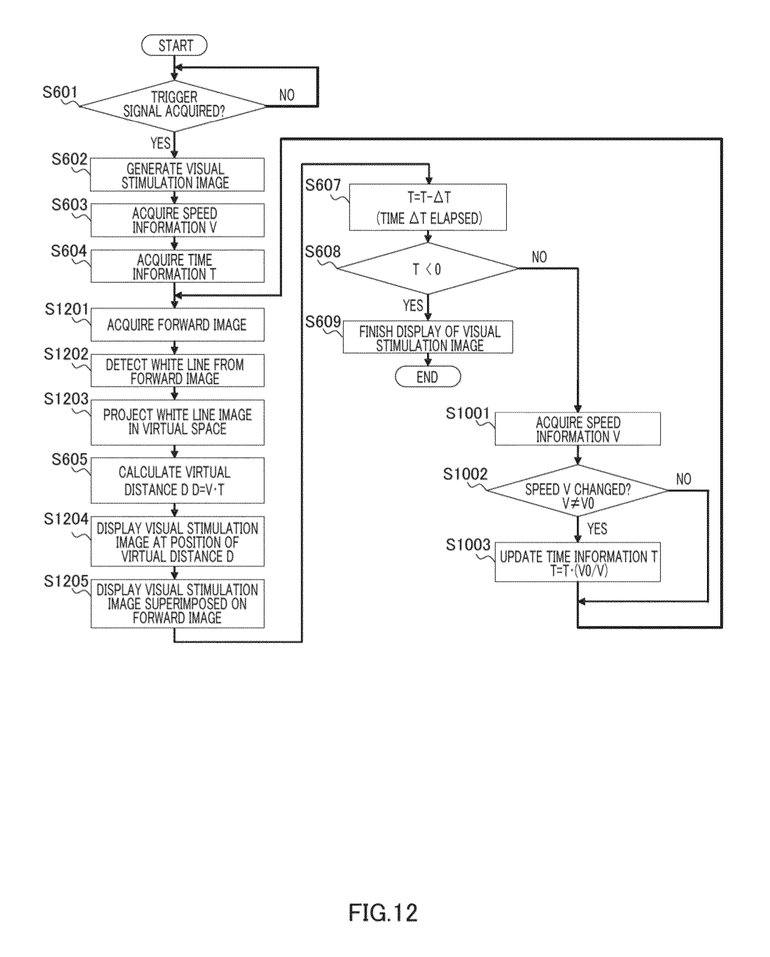

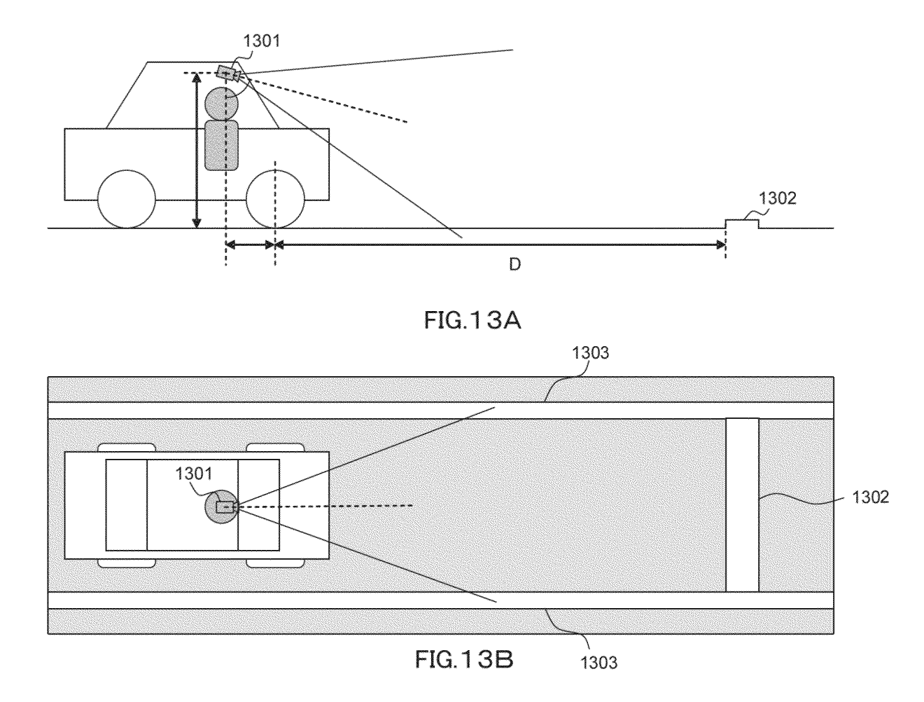

The present embodiment will describe a case where the road shape is detected using a painted line on the road surface. FIG. 12 is a flowchart illustrating operation of visual stimulation control section 1101. FIG. 13 is a diagram illustrating a positional relationship between a vehicle, camera, visual stimulation virtual object and painted line. FIG. 13A illustrates a positional relationship in a real space and FIG. 13B illustrates a positional relationship when FIG. 13A is viewed from right above.

In step S1201, visual stimulation control section 1101 acquires an image in front of the vehicle photographed by camera 1301.

Visual stimulation control section 1101 detects an image of painted line 1303 from the forward image in step S1202 and projects it in a virtual space in step S1203.

In step S1204, visual stimulation control section 1101 performs control of displaying a visual stimulation image at a displaying position corresponding to virtual distance D. In this case, the visual stimulation image is displayed at a position in accordance with the road shape calculated from the position of the painted line. To be more specific, the visual stimulation image may be displayed at the position at virtual distance D along the road shape or the visual stimulation image in a size adjusted to the road width may be displayed.

In step S1205, visual stimulation control section 1101 performs control of displaying the image of visual stimulation virtual object 1302 superimposed on the forward image.

Here, the visual stimulation image is displayed directly on the forward image of the vehicle, but the virtual space illustrated in FIG. 13B may also be displayed.

A case has been described here where visual stimulation control section 1101 is applied to the configuration of the awakened-state maintaining apparatus described in Embodiment 2, but the present invention is not limited to this, and visual stimulation control section 1101 may also be applied to the configuration of the awakened-state maintaining apparatus described in Embodiment 1.

As described above, according to the present embodiment, visual stimulation control section 1101 in awakened-state maintaining apparatus 1100 detects the road shape from the forward image of the vehicle, generates a visual stimulation image based on the road shape and displays the forward image superimposed on the visual stimulation image.

As the method of detecting the road shape, a road side object such as a guard rail may be detected using a camera or the road shape may be detected using position/posture information of the vehicle and map information.

By so doing, it is possible to realize a realistic display and increase the awakened-state maintaining effect.

A case has been described above assuming that sense stimulation control section 703 includes audio signal control section 701 and vibration control stimulation section 702, but sense stimulation control section 703 may include one of the two. In such a case, the trigger signal outputted from trigger section 102, vehicle speed outputted from speed information acquiring section 103 and time information outputted from timing control section 104 are outputted to sense stimulation control section 703 one by one. When sense stimulation control section 703 includes only audio signal control section 701, the trigger signal, vehicle speed and time information are outputted to audio signal control section 701. When sense stimulation control section 703 includes only vibration control stimulation section 702, the trigger signal, vehicle speed and time information are outputted to audio signal control section 702. This makes it possible to obtain effects enough to maintain the driver's awakened-state even with a small number of parts.

### Embodiment 4

Embodiment 4 will detect the driver's eyeball position, generate a visual stimulation image so that a visual stimulation virtual object is appropriately displayed on a front window according to the eyeball position and display the generated visual stimulation image on the front window.

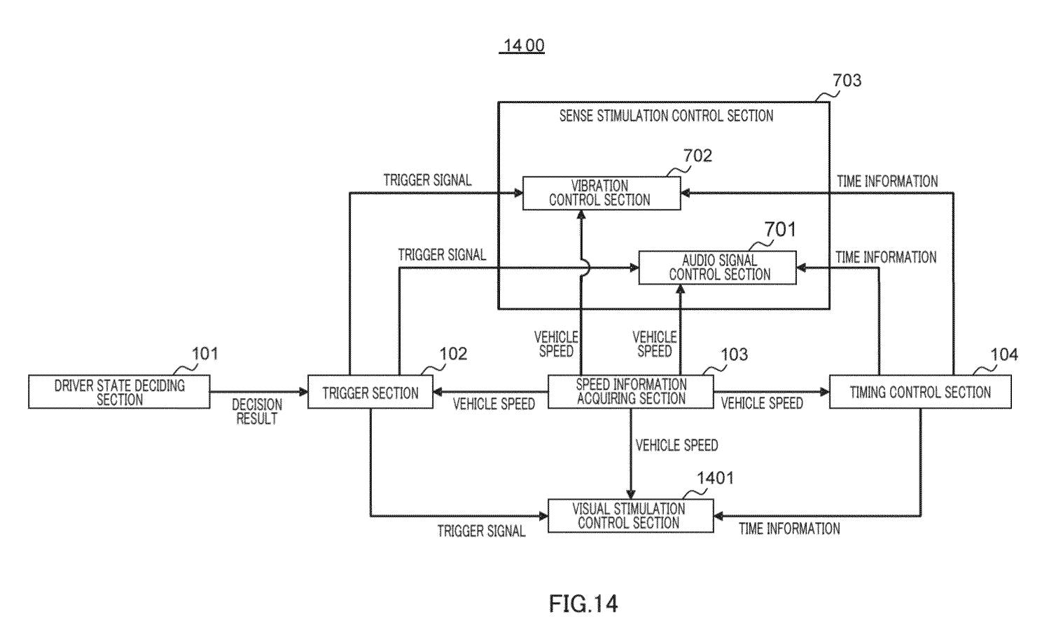

FIG. 14 is a block diagram illustrating a configuration of awakened-state maintaining apparatus 1400 according to Embodiment 4 of the present invention. In FIG. 14, awakened-state maintaining apparatus 1400 includes driver state deciding section 101, trigger section 102, speed information acquiring section 103, timing control section 104, sense stimulation control section 703 and visual stimulation control section 1401. In the present embodiment, the same components as those in Embodiment 1 to Embodiment 3 will be assigned the same reference numerals and descriptions thereof will be omitted.

The present embodiment will describe a case where an eyeball position is detected using a camera.

Visual stimulation control section 1401 basically has a function similar to that of visual stimulation control section 1101. Visual stimulation control section 1401 detects the driver's eyeball position based on an image of the driver's face photographed by the camera mounted in the vehicle room of the vehicle.

Visual stimulation control section 1401 then projects a visual stimulation virtual object placed in a virtual space viewed from the detected eyeball position onto the front window and generates a visual stimulation image to display the projected image. Visual stimulation control section 1401 displays the generated visual stimulation image on the front window using a projector or the like.

To be more specific, visual stimulation control section 1401 places a virtual camera at the driver's eyeball position in the virtual space. Furthermore, visual stimulation control section 1401 places visual stimulation virtual object 1302 at a position at virtual distance D from the vehicle in the virtual space. Furthermore, visual stimulation control section 1401 places a front window in the virtual space (hereinafter referred to as “virtual front window”) at the position of the front window in the real space.

Visual stimulation control section 1401 then calculates an intersection between a straight line connecting the virtual camera to visual stimulation virtual object 1302 in the virtual space, and the virtual front window. A group of the calculated intersections is called “visual sense stimulation object projected image.” Visual stimulation control section 1401 then generates visual stimulation image 1801 to display the visual sense stimulation object projected image on the front window using the projector and displays the image on the front window using the projector.

Operation of awakened-state maintaining apparatus 1400 having such a configuration will be described.

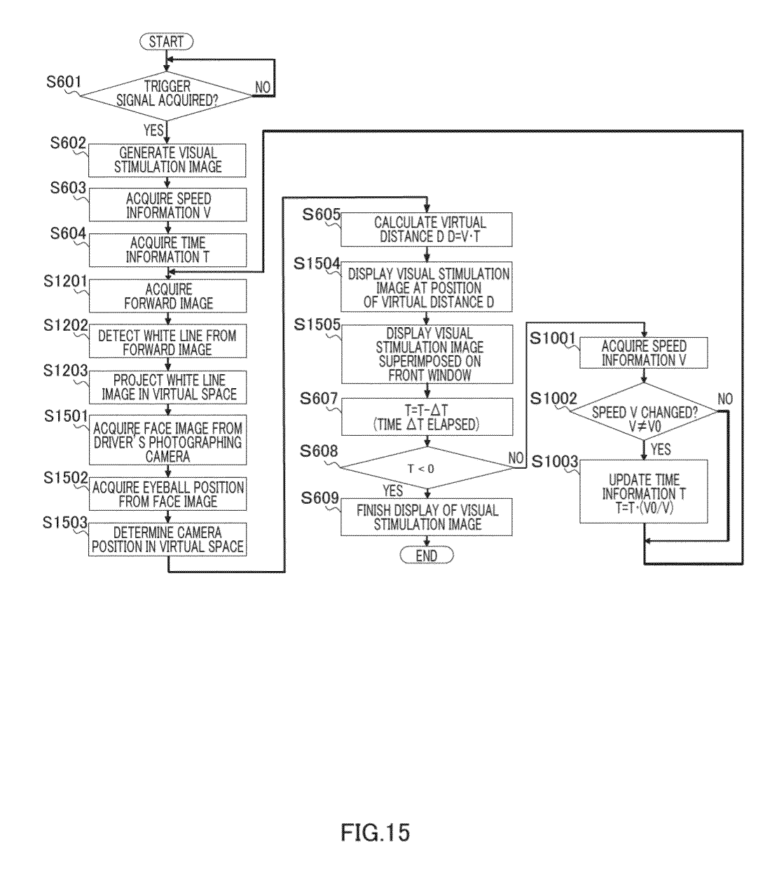

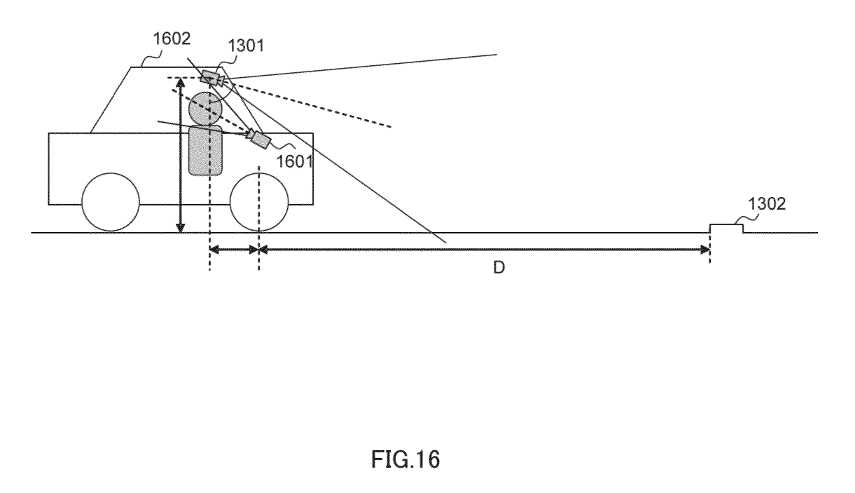

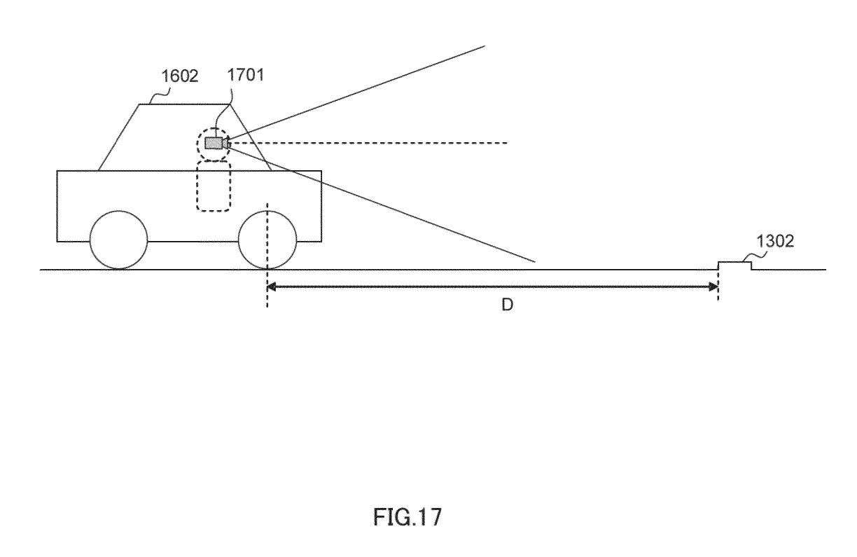

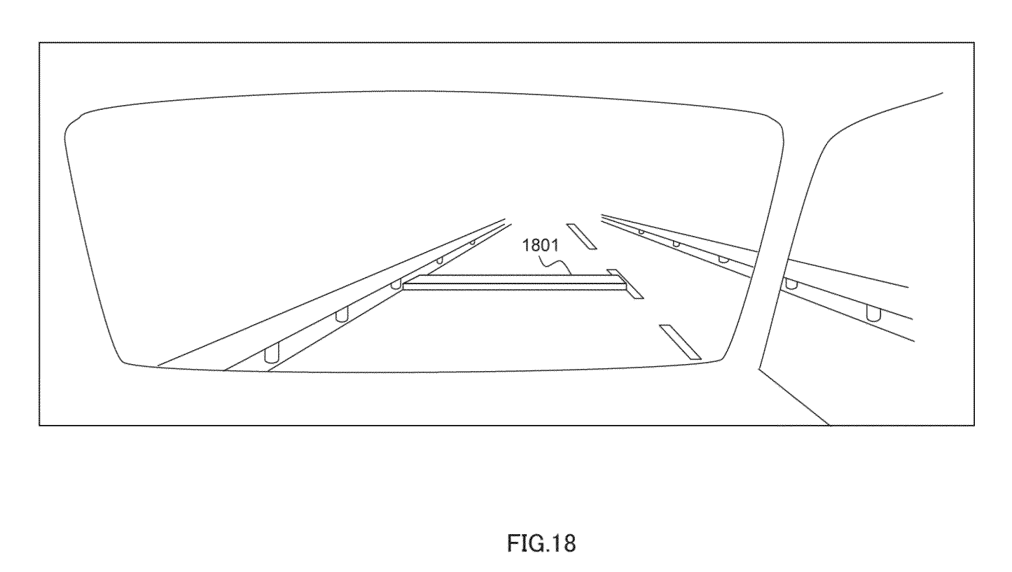

FIG. 15 is a flowchart illustrating operation of visual stimulation control section 1401. FIG. 16 and FIG. 17 are diagrams illustrating a positional relationship between the vehicle, camera and visual stimulation virtual object. FIG. 16 illustrates the positional relationship in the real space and FIG. 17 illustrates the positional relationship in the virtual space. FIG. 18 is a diagram illustrating visual stimulation image 1801 displayed in the front window viewed from the viewpoint of the driver.

Visual stimulation control section 1401 acquires a face image from driver camera 1601 in step S1501 and detects the eyeball position based on the face image in step S1502.

Here, driver camera 1601 may be constructed of one camera or a plurality of cameras. Driver camera 1601 constructed of a plurality of cameras can respond to a wide range of face movement. An infrared camera may also be used for driver camera 1601. This allows the system to be applicable to a dark environment, too. Furthermore, forward camera 1301 is made up of at least two cameras spaced apart by a predetermined distance or more. This allows the driver to spatially grasp the photographed image.

In step S1503, visual stimulation control section 1401 determines the detected eyeball position as the setup position for virtual camera 1701 and places virtual camera 1701 at the setup position in the virtual space.

In step S1504, visual stimulation control section 1401 places visual stimulation virtual object 1302 at the position in the virtual space corresponding to virtual distance D between the vehicle in the real space and visual stimulation virtual object 1302.

In step S1505, visual stimulation control section 1401 displays on the display section (that is, front window 1602), visual stimulation image 1801 which is the image of visual stimulation virtual object 1302 placed in the virtual space and projected onto the display section assuming the position of virtual camera 1701 as a focus point.

As described above, according to the present embodiment, visual stimulation control section 1401 in awakened-state maintaining apparatus 1400 detects the position of the eye and the direction of the line of sight from the driver's face image and causes the projected image which is the image of visual stimulation virtual object 1302 projected onto the display section to be displayed as visual stimulation image 1801 based on the position of the eye and the direction of the line of sight.

This makes it possible to always display visual stimulation image 1801 at an appropriate position of a landscape in front of the vehicle and increase the awakened-state maintaining effect.

As the method of detecting the eyeball position, the eyeball position may be detected by tracking a sensor attached to the head using a tracker or using a magnetic sensor attached to the head or using an ultrasound sensor or using whatsoever methods capable of detecting the eyeball position.

Furthermore, although the front window is used as the display place in the present embodiment, the display place may be a display of a car navigation system or an instrumental panel or whatever place allowing the image to be displayed.

### Embodiment 5

In addition to determining the output timing of a trigger signal based on the driver's awakened-state level as in the case of Embodiment 1, Embodiment 5 determines the output timing of a trigger signal based on whether or not the vehicle is passing through a specific section.

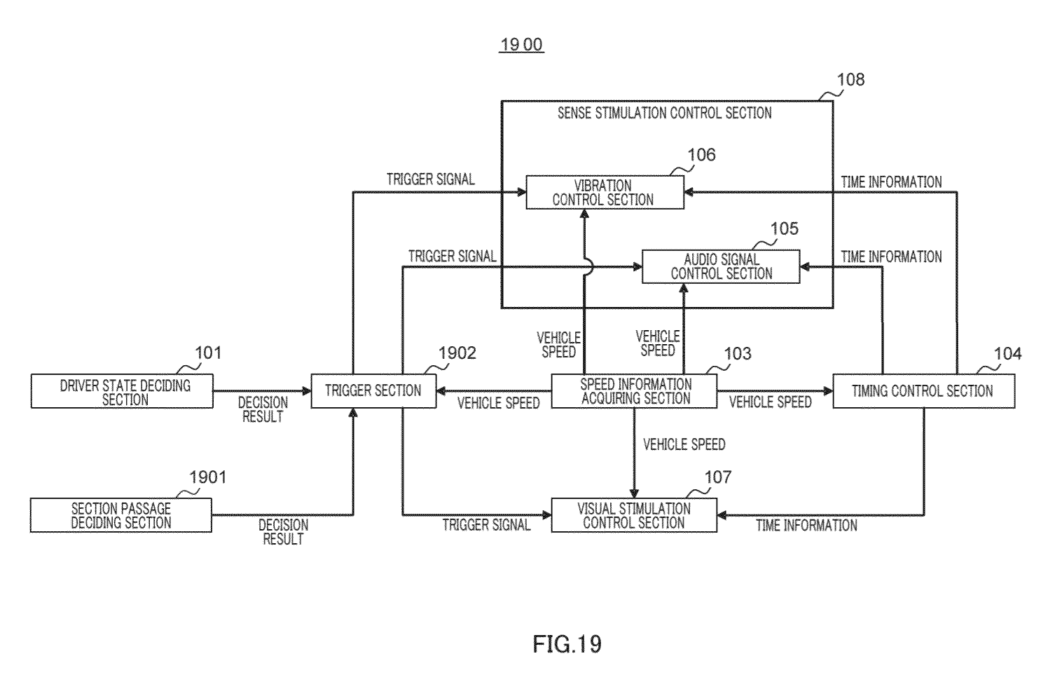

FIG. 19 is a block diagram illustrating a configuration of awakened-state maintaining apparatus 1900 according to Embodiment 5 of the present invention. In FIG. 19, awakened-state maintaining apparatus 1900 includes driver state deciding section 101, speed information acquiring section 103, timing control section 104, sense stimulation control section 108, visual stimulation control section 107, section passage deciding section 1901 and trigger section 1902. In the present embodiment, the same components as those in Embodiment 1 to Embodiment 4 will be assigned the same reference numerals and descriptions thereof will be omitted.

Section passage deciding section 1901 acquires information (hereinafter referred to as “output section information”) indicating a section during which a trigger signal should be outputted (hereinafter referred to as “trigger output section”) beforehand and decides whether or not the vehicle is located in the trigger output section.

To be more specific, section passage deciding section 1901 acquires the output section information via a network or the like and decides whether or not the vehicle is located within a section indicated by the output section information using position information of a car navigation system or the like.

As the trigger output section, for example, a section where there is a high incidence of drowsy driving accidents according to traffic accident statistics may be used. Furthermore, the trigger output section may be a section where the driver's awakened-state level was low based on a decision result by driver state deciding section 101 in the past or a section where the driver's awakened-state level of another driver was frequently low based on a decision result by driver state deciding section 101.

As the method of acquiring the output section information, for example, a carrier network of mobile phones or beacons set up on roadsides or the like may be used. The output section information may be stored by section passage deciding section 1901 beforehand. Alternatively, updated information may be downloaded using a storage medium or network.

Trigger section 1902 basically has a function similar to that of trigger section 102. Trigger section 1902 outputs a trigger signal to audio signal control section 105, vibration control section 106 and visual stimulation control section 107 based on the decision result of section passage deciding section 1901. That is, when section passage deciding section 1901 decides that the vehicle is located within the trigger output section, trigger section 1902 outputs a trigger signal. The rest of operation of trigger section 1902 is similar to that of trigger section 102 of Embodiment 1.

Operation of awakened-state maintaining apparatus 1900 having the above-described configuration will be described.

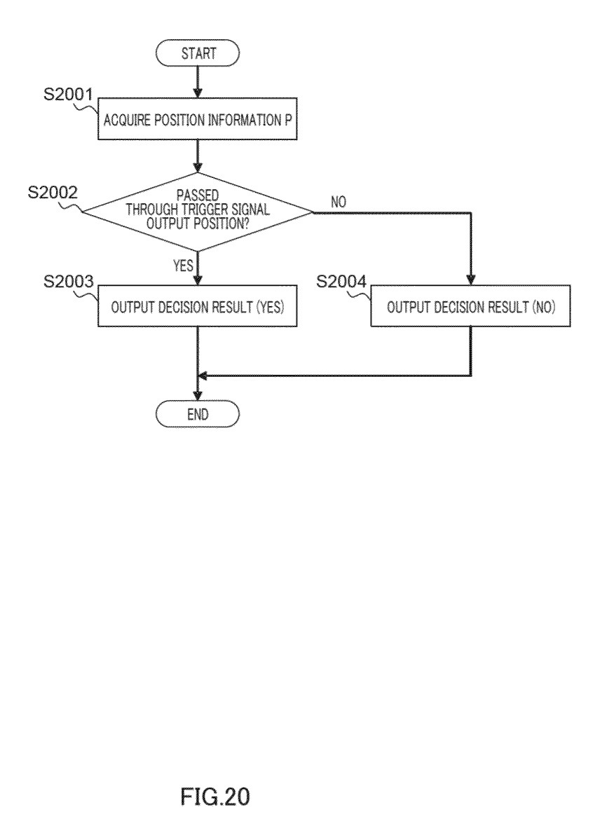

FIG. 20 is a flowchart illustrating operation of section passage deciding section 1901.

Section passage deciding section 1901 acquires position information P in step S2001, decides whether or not acquired position information P is within a trigger output section in step S2002, and outputs, when position information P is within the section (Yes), a decision result indicating that position information P is within the section to trigger section 1902 in step S2003 and outputs, when position information P is outside the section (No), a decision result indicating that position information P is outside the section to trigger section 1902 in step S2004.

As described above, according to the present embodiment, section passage deciding section 1901 in awakened-state maintaining apparatus 1900 decides whether or not the vehicle is located within a section where a trigger signal should be outputted, and when the vehicle is located within the section, trigger section 1902 outputs a trigger signal to audio signal control section 105, vibration control section 106 and visual stimulation control section 107.

By so doing, it is possible to present stimulation in sections prone to cause deterioration in the awakened-state and increase the awakened-state maintaining effect.

### Embodiment 6

In addition to determining output timing of a trigger signal based on the driver's awakened-state level as in the case of Embodiment 1, Embodiment 6 determines output timing of a trigger signal based on whether or not the vehicle has passed through a specific section.

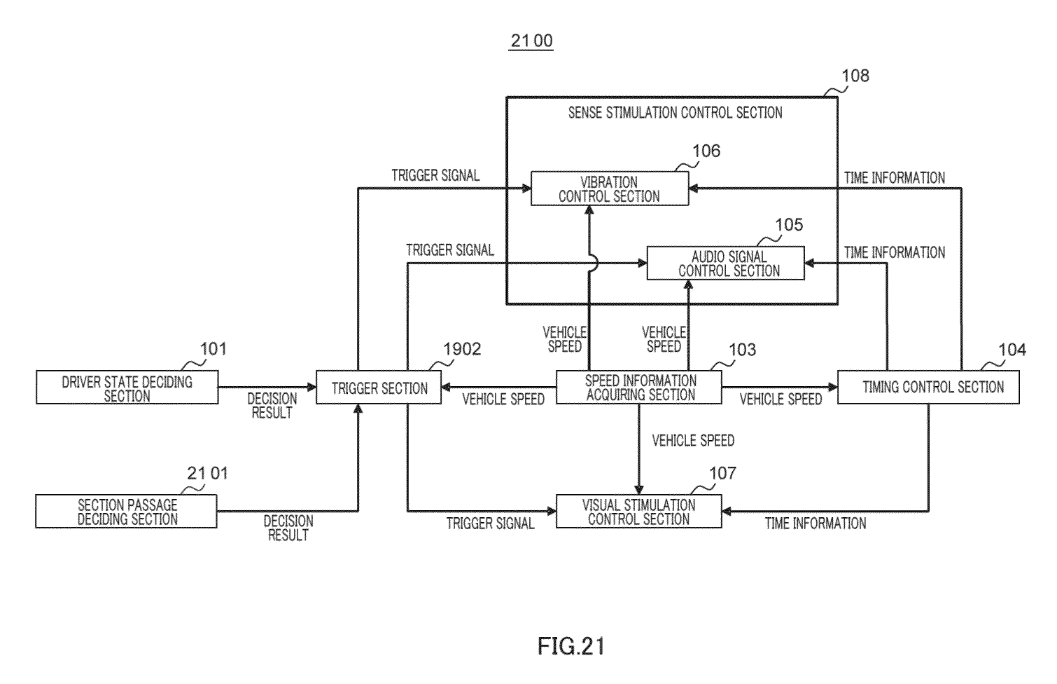

FIG. 21 is a block diagram illustrating a configuration of awakened-state maintaining apparatus 2100 according to Embodiment 6 of the present invention. In FIG. 21, awakened-state maintaining apparatus 2100 includes driver state deciding section 101, speed information acquiring section 103, timing control section 104, sense stimulation control section 108, visual stimulation control section 107, section passage deciding section 2101 and trigger section 1902. In the present embodiment, the same components as those in Embodiment 1 to Embodiment 5 will be assigned the same reference numerals and descriptions thereof will be omitted.

Section passage deciding section 2101 decides whether or not information indicating that the vehicle approaches a trigger output section (hereinafter referred to as “output section approach information”) has been acquired.

To be more specific, section passage deciding section 2101 always monitors whether or not output section approach information has been acquired, and informs, immediately after acquiring the output section approach information, trigger section 1902 that the vehicle has approached the trigger output section.

As the trigger output section, for example, a section where there is a high incidence of drowsy driving accidents according to traffic accident statistics is used. Furthermore, the trigger output section may be a section where the driver's awakened-state level was low based on a decision result by driver state deciding section 101 in the past or a section where the driver's awakened-state level of another driver was frequently low based on a decision result by driver state deciding section 101.

As the method of acquiring the output section approach information, for example, a carrier network of mobile phones or beacons set up on roadsides or the like may be used.

Operation of awakened-state maintaining apparatus 2100 having the above-described configuration will be described.

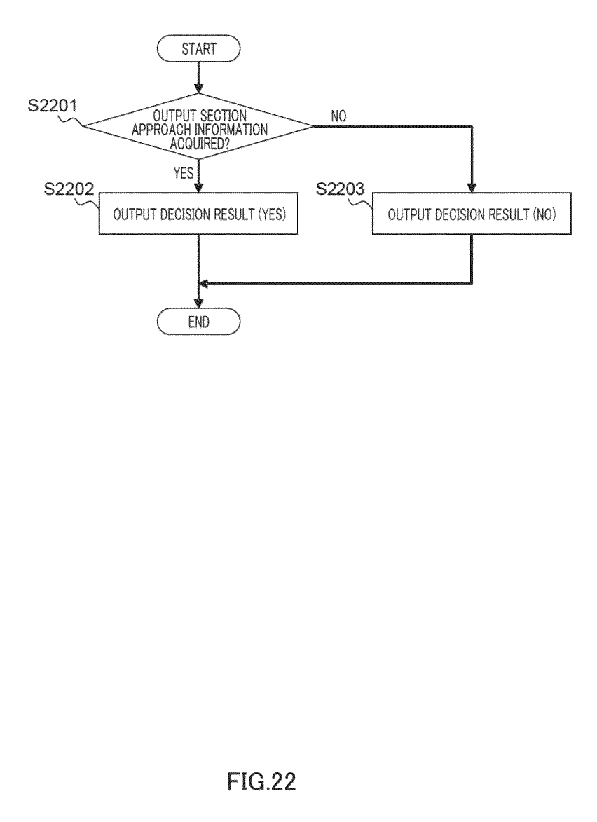

FIG. 22 is a flowchart illustrating operation of section passage deciding section 2101.

Section passage deciding section 2101 decides in step S2201 whether output section approach information has been acquired, and outputs, when acquired (Yes), a decision result indicating that the vehicle is located inside the section to trigger section 1902 in step S2202, and outputs, when not acquired (No), a decision result indicating that the vehicle is located outside the section to trigger section 1902 in step S2203.

As described above, according to the present embodiment, section passage deciding section 2101 in awakened-state maintaining apparatus 2100 decides whether or not the vehicle approaches the section in which case a trigger signal should be outputted, and when the vehicle approaches the section, trigger section 2102 outputs a trigger signal to audio signal control section 105, vibration control section 106 and visual stimulation control section 107.

By so doing, it is possible to present stimulation in sections prone to cause deterioration in the awakened-state and increase the awakened-state maintaining effect.

Instead of section passage deciding section 2101 making a decision using output section approach information, section passage deciding section 2101 may make a decision based on whether or not information indicating that the vehicle is located within the trigger output section (“output section internal location information”) has been acquired. Upon acquiring the output section internal location information, section passage deciding section 2101 may inform trigger section 1902 that the vehicle is located within the trigger output section, and inform, when the next output section information cannot be acquired by the time a predetermined timeout time elapses, trigger section 1902 that the vehicle is located within the trigger output section.

Moreover, although cases have been described with the embodiments above where the present invention is configured by hardware, the present invention may be implemented by software in conjunction with hardware.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2010-107419, filed on May 7, 2010, including the specification, drawings and abstract is incorporated herein by reference in its entirety.

### INDUSTRIAL APPLICABILITY

The awakened-state maintaining apparatus and awakened-state maintaining method according to the present invention are suitable for use in displaying an image to stimulate the driver's visual sense, generating a sound to stimulate the auditory sense and vibration to stimulate the tactual sense according to the traveling state of the vehicle, and thereby maintaining the driver's awakened-state.

### REFERENCE SIGNS LIST

100, 700, 1100, 1400, 1900, 2100 Awakened-state maintaining apparatus
101 Driver state deciding section
102, 1902 Trigger section
103 Speed information acquiring section
104 Timing control section
105, 701 Audio signal control section
106, 702 Vibration control section
107, 704, 1101, 1401 Visual stimulation control section
108, 703 Sense stimulation control section
1901, 2101 Section passage deciding section

1-7. (canceled)

8. An awakened-state maintaining apparatus for maintaining an awakened-state of a driver of a vehicle, comprising:
a speed information acquiring section that acquires information on a speed of the vehicle;
a timing control section that calculates time information based on the speed;
a trigger section that outputs a trigger signal at a predetermined time interval;
a visual sense stimulation control section that calculates, upon acquiring the trigger signal, a virtual distance in accordance with the product of the time information and the speed, places a visual stimulation virtual object at a position apart by the virtual distance from the vehicle in a virtual space, generates and displays a visual stimulation image to display the visual stimulation virtual object according to a predetermined display method, counts down the time information from the display timing and displays the visual stimulation image wherein the visual stimulation virtual object is placed at a position in accordance with the product of the time information and the speed; and
a sense stimulation control section that counts down the time information from the display timing and outputs an audio signal or vibration when the time information falls below zero.

9. The awakened-state maintaining apparatus according to claim 8, wherein when the speed changes, the visual sense stimulation control section and the sense stimulation control section update the time information counted down based on speeds before and after the change.

10. The awakened-state maintaining apparatus according to claim 8, wherein the visual sense stimulation control section generates a visual stimulation image in accordance with the road shape forward of the vehicle and displays the visual stimulation image superimposed on the forward image of the vehicle.

11. The awakened-state maintaining apparatus according to claim 8, wherein the display control section detects the driver's eyeball position and displays the visual stimulation virtual object as the visual stimulation image based on the eyeball position.

12. The awakened-state maintaining apparatus according to claim 8, further comprising a section passage deciding section that decides whether or not the vehicle passes through a specific section,
wherein when the section passage deciding section decides that the vehicle passes through the specific section, the trigger section outputs the trigger signal.

13. An awakened-state maintaining method for maintaining an awakened-state of a driver of a vehicle, comprising:
a speed information acquiring section acquiring information on a speed of the vehicle;
a timing control section calculating time information based on the speed;
a trigger section outputting a trigger signal at a predetermined time interval;
a visual sense stimulation control section calculating, upon acquiring the trigger signal, a virtual distance in accordance with the product of the time information and the speed, placing a visual stimulation virtual object at a position apart by the virtual distance from the vehicle in a virtual space, generating and displaying a visual stimulation image to display the visual stimulation virtual object according to a predetermined display method, counting down the time information from the display timing and displaying the visual stimulation image wherein the visual stimulation virtual object is placed at a position in accordance with the product of the time information and the speed; and
a sense stimulation control section counting down the time information from the display timing and outputting an audio signal or vibration when the time information falls below zero.
